(19) United States
(12) Patent Application Publication
(10) Pub. No.: US 2023/0028072 A1
(43) Pub. Date: Jan. 26, 2023

(54) PLANT WATERING DEVICE AND SYSTEM

(71) Applicant: Sandro IULIANO, Rose Park (AU)

(72) Inventor: Sandro IULIANO, Rose Park (AU)

(21) Appl. No.: 17/788,217

(22) PCT Filed: Dec. 22, 2020
(86) PCT No.: PCT/AU2020/000143

§ 371 Date: Jun. 22, 2022

(30) Foreign Application Priority Data
Dec. 23, 2019 (AU) 2019904893

(51) Int. Cl. A01G 27/00; A01G 13/02; A01G 29/00

(52) U.S. Cl. CPC A01G 27/006; A01G 13/0212; A01G 29/00; A01G 27/008

(57) ABSTRACT

Disclosed is a plant watering device comprising a body forming a well for receiving water; at least one plant aperture disposed in the well for receiving a plant; and at least one water aperture disposed in a base of the well for allowing water to pass therethrough. In some embodiments, there is also provided a disk rotatably disposed in the well, the disk comprising a body, at least one blade on one side of the body such that in use, upon rotation by a user of the disk within the well, the blade scrapes along the base of the well. In other embodiments, a dome is connectable to the device to provide a green-house effect. The system disclosed provides for an efficient and environmentally-friendly means of watering plants.

### TECHNICAL FIELD

The present application relates to watering of plants in domestic and industrial applications.

### PRIORITY

This application claims priority from Australian Provisional Patent Application No. 2019904893 entitled PLANT WATERING DEVICE AND SYSTEM filed on 23 Dec. 2019.

The content of this provisional application is hereby incorporated by reference in its entirety.

### BACKGROUND

There are numerous agricultural techniques used to grow and water plants or crops, with each technique dependent on the type of plant or crop, soil type, topography (environment), resources available, and climatic conditions. A factor when considering watering is the ability to provide sufficient water to the ‘root zone’ of the plant and avoid excess watering which permeates below this zone otherwise known as ‘deep percolation’. Additionally, too much surface water can also lead to downstream wastage known as ‘run-off’ particularly dependent on the land slope.

Various watering techniques include surface irrigation, sprinkler irrigation, drip irrigation, subsurface irrigation, hydroponics and by the use of pot plants. Many of these however, suffer from various drawbacks, which are summarised below.

Surface irrigation is essentially the provision of water to the surface of soil from which the plants grow. This is a common technique, however, it is necessary that the land be essentially level to ensure uniform flow and distribution of the water. Additionally, the varying permeability of the site soil may provide differing water penetration hence the importance of tilling the land for better uniformity of soil profile. There are several methods of surface irrigation which essentially allows the flow and dispersion of the water over a large area, at the expense of large water consumption. This method has been typically used for thousands of years and is still in practice today due to otherwise resource expensive alternatives.

Sprinkler irrigation is a means of providing water to crops being similar to rainfall. This method is specifically adaptable to uneven land or densely grown crops including lawns. However, sprinkling water on crops is not ideal for all plant types which may be prone to foliage disease. Furthermore, water loss due to evaporation, wind drift and unnecessary watering of walking or machinery paths reduces efficiency.

Drip irrigation provides for more focused use of water to the plant or crop, by a carefully designed hydraulic pipework system thus enabling reduction in water requirements and minimised loss due to evaporation. However, such a system is complex, expensive to design and implement, as well as being crucial to maintain the installed system to ensure that all plants continue to receive water as required.

Hydroponics is a relatively new method of growing plants without soil and providing the necessary water and nutrients in solution by means of a circulating pipework system, thus greatly reducing water loss. Further benefits incurred from better area utilisation. However, the necessary greenhouse environment and the running costs of electricity contribute to these systems having high start-up costs and long returns on investment. In commercial applications, some of these costs are outweighed by not needing large farming machinery for soil preparation, much reduced herbicides or their maintenance in generating clean produce. These systems however require much monitoring to ensure prevention of water borne disease which can rapidly damage crops.

Pot plants have their place mostly in domestic applications whereby there is less maintenance necessary of individual plants. Watering is simplified but soil compaction and root expansion are some factors which negate their efficiency on larger scales. Practically at best this system is limited to the initial propagation of seedlings in commercial application.

It would be advantageous to provide a device, system and/or method that addresses at least one of the problems associated with current systems, or at least to provide a useful alternative.

### SUMMARY

According to a first aspect, there is provided a plant watering device comprising a body forming a well for receiving water; at least one aperture disposed in the well; and at least one connector for engaging with a corresponding connector of another plant watering device.

In some embodiments, the at least one aperture is a plant aperture for receiving at least a part of the plant.

In some embodiments, the at least one aperture is a water aperture for allowing water in the well to pass therethrough.

In some embodiments, the plant watering device comprises a plurality of apertures, at least one aperture being a plant aperture for receiving at least a part of the plant and at least one aperture being a water aperture for allowing water in the well to pass therethrough.

In some embodiments, the plant watering device further comprises a base for contacting the ground when in use.

In some embodiments, the base is angled with respect to a top of the plant watering device.

In some embodiments, the plant watering device further comprises a base cover, forming a substantially closed void between the base cover and the body.

In some embodiments, the plant watering device comprises a dome covering the well.

In some embodiments, the plant watering device comprises a dome connector for connecting a detachable dome covering the well.

In some embodiments, the plant watering device comprises the dome connected thereto.

In some embodiments, the plant watering device further comprises a means for receiving a part of an external irrigation system for providing the water to the well.

According to a second aspect, there is provided a plant watering device comprising a body forming a well for receiving water; at least one aperture disposed in the well; and a dome connector for attaching a dome to cover the well.

According to a third aspect, there is provided a dome for use with a plant watering device according to the first and second aspects, the dome comprising a dome aperture at a top of the dome; and a dome aperture plug disposed at the dome aperture and moveable between a closed position and an open position, the open position providing for airflow and/or water ingress through the dome aperture.

According to a fourth aspect, there is provided a plant watering device comprising a body forming a well for receiving water; at least one aperture disposed in the well; and a base cover connector for connecting a base for forming a closed void between the base and the body for receiving material within the void.

According to a fifth aspect, there is provided a plant watering system comprising two or more plant watering devices according to any of the first, second and fourth aspects.

In some embodiments, the two or more plant watering devices are connected together via at least one of their respective connectors.

In some embodiments, the two or more watering devices each receive, in use, a plant through their respective at least one aperture.

According to a sixth aspect, there is provided a method of watering a plant, the method comprising providing water to the well of at least one plant watering device according to any of the first, second and fourth aspects.

According to a seventh aspect, there is provided a method of watering a plurality of plants, the method comprising providing water to the respective wells of the two or more plant watering devices of the system of the fifth aspect.

According to an eighth aspect, there is provided a plant watering device comprising: a body forming a well for receiving water; and a plurality of apertures disposed in the well; wherein the body comprises an extruded section with an end cap at each end.

According to a ninth aspect, there is provided a plant watering device comprising: a body forming a well for receiving water; at least one plant aperture disposed in the well for receiving a plant; at least one water aperture disposed in a base of the well for allowing water to pass therethrough; and a disk rotatably disposed in the well, the disk comprising a body, at least one blade on one side of the body such that in use, upon rotation by a user of the disk within the well, the blade scrapes along the base of the well.

### BRIEF DESCRIPTION OF DRAWINGS

Embodiments of the various aspects described herein will be detailed with reference to the accompanying drawings in which:

FIG. 1—shows a general form of a plant watering device according to an aspect described herein;

FIG. 2—shows an embodiment of the plant watering device of FIG. 1;

FIG. 3—shows the plant watering device of FIGS. 1 and 2 in use with a plant;

FIG. 4—shows a side view of a system, being a series of plant watering devices of FIGS. 1 and 2 connected together;

FIG. 5—shows a top view of the system of FIG. 4;

FIG. 6—shows a side cross-sectional view of the plant watering device with an angled base for use on a slope;

FIG. 7—shows another embodiment of the plant watering device with an angled base;

FIG. 8—shows a side view of a system of a series of plant watering devices of FIG. 6 on a slope;

FIG. 9—shows a plant watering device including a base cover providing a cavity;

FIG. 10—shows the plant watering device of FIG. 9 with weighting material in the cavity;

FIG. 11—shows a plant watering device with a dome;

FIG. 12—shows a plant watering device with a dome connector;

FIG. 13—shows a plant watering device with a dome connected to the body via the dome connector;

FIG. 14—shows a plant watering device with an irrigation means in the body;

FIG. 15—shows a general plant watering device with a dome connector;

FIG. 16—shows a general plant watering device with a base cover connector;

FIG. 17A—shows a top view of an embodiment of a plant watering device;

FIG. 17B—shows a side cross-sectional view along the line A-A of the plant watering device of FIG. 17A;

FIG. 18A—shows a top view of an embodiment of a base cover for use with the plant watering device of FIGS. 17A and 17B;

FIG. 18B—shows a side view of the base cover of FIG. 18A;

FIG. 19A—shows a top view of an embodiment of a dome;

FIG. 19B—shows a side view of a plant watering device with the dome of FIG. 19A engaged with the body of the plant watering device;

FIG. 20—shows a plant watering device with a dome having a dome aperture and a dome aperture plug;

FIG. 21A—shows a top view of an embodiment of a plant watering device with a single well;

FIG. 21B—shows a top view of an embodiment of a plant watering device with two wells;

FIG. 21C—shows a top view of an embodiment of a plant watering device with four wells;

FIG. 21D—shows a top view of an embodiment of a plant watering device with a single well but with multiple plant apertures;

FIG. 22A—shows a side view of a plant watering device of FIG. 21C with an angled base;

FIG. 22B—shows a side view of a plant watering device of FIG. 21D with an angled base;

FIG. 23—shows a top view of a plant watering device with a central filling well surrounded by four wells with respective plant apertures;

FIG. 24—shows a plant watering device with a central plant aperture with four wells surrounding the plant aperture;

FIG. 25A—shows a perspective view of another embodiment of the plant watering device provided as a valley section;

FIG. 25B—shows an embodiment of an end cap for use with the valley section of FIG. 25A;

FIG. 25C—shows another view of the end cap for use with the valley section of FIG. 25A;

FIG. 25D—shows a perspective view of the valley section of FIG. 25A with two end caps of FIGS. 25A and 25B;

FIG. 26—shows a perspective view of an embodiment of a spigot for use with the plant watering device of FIG. 25D;

FIG. 27—shows a perspective view of an embodiment of a plug for use with the plant watering device of FIG. 25D;

FIG. 28A—shows a top perspective view of another embodiment of the plant watering device;

FIG. 28B—shows a bottom perspective view of the device of FIG. 28A;

FIG. 28C—shows a cross-sectional view of the device of FIG. 28A;

FIG. 29A—shows a top perspective view of a disk for use with the plant watering device of FIG. 28A;

FIG. 29B—shows a bottom perspective view of the disk of FIG. 29A;

FIG. 29C—shows a side view of the disk of FIG. 29A;

FIG. 29D—shows a cross-sectional view of the device of FIG. 28A with the disk of FIG. 29A inserted therein;

FIG. 30A—shows a bottom perspective view of another embodiment of a dome for use with the device of FIG. 28A;

FIG. 30B—shows a top perspective view of the dome of FIG. 30A;

FIG. 30C—shows a side view of the dome of FIG. 30A;

FIG. 31A—shows an assembly of the device of FIG. 28A, the dome of FIG. 30A and a plug inserted in the dome aperture, in an open position;

FIG. 31B—shows a bottom perspective view of the assembly of FIG. 31A;

FIG. 31C—shows a side view of the assembly of FIG. 31A with the plug in a closed position;

FIG. 32A—shows a top perspective view of an embodiment of the plug for use in the assembly of FIG. 31A;

FIG. 32B—shows a bottom perspective view of the plug of FIG. 32A;

FIG. 33A—shows a top perspective view of another embodiment of a plant watering device for use with pavers;

FIG. 33B—shows a bottom perspective view of the device of FIG. 33A;

FIG. 34A—shows a top perspective view of another embodiment of a plant watering device for use with pavers;

FIG. 34B—shows a bottom perspective view of the device of FIG. 34A;

FIG. 35A—shows a top perspective view of another embodiment of a plant watering device for use with pavers;

FIG. 35B—shows a bottom perspective view of the device of FIG. 35A;

FIG. 36A—shows a top perspective view of a plant watering device for use as a paver; and

FIG. 36B—shows a bottom perspective view of the device of FIG. 36A.

### DESCRIPTION OF EMBODIMENTS

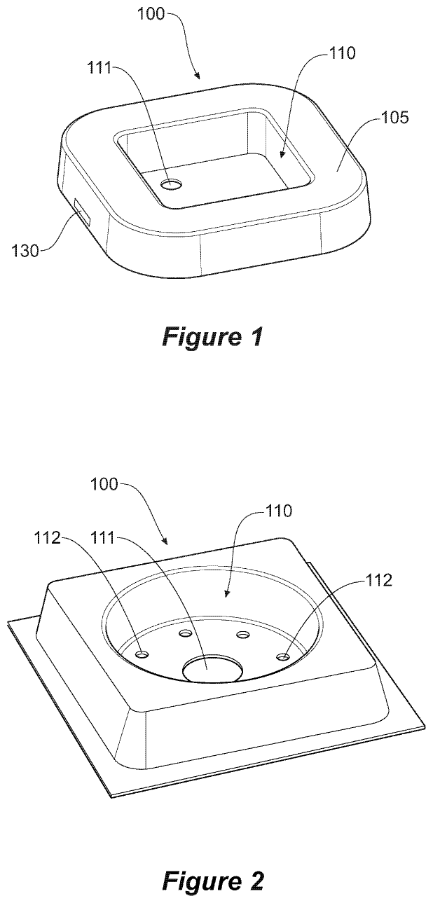

FIG. 1 shows a perspective view of a general plant watering device 100 according to one aspect described herein. In this aspect, plant watering device 100 comprises a body 105, within which is formed, provided or otherwise disposed, a well 110. The well, 110, is for receiving water, as will be described in more detail below.

At, or near, the bottom of the well 110, is at least one aperture 111. Aperture 111 can be used for receiving a part (such as the stalk) of a plant (not shown in this view), and/or for allowing water within well 110 to pass therethrough, to enter the soil around the plant.

In this aspect, plant watering device 100 also comprises a connector shown generally as 130 for allowing connection of the plant watering device 100 to another plant watering device 100′ (see further below).

Accordingly, there is provided in one aspect, a plant watering device comprising: a body forming a well for receiving water; at least one aperture disposed in the well; and at least one connector for engaging with a corresponding connector of another plant watering device.

In some embodiments, as shown in FIG. 2, plant watering device 100 comprises a plurality of apertures in the well 110. In some embodiments, at least one aperture 111 is a plant aperture for receiving a part of the plant as previously described. In some embodiments, the aperture is a water aperture 112, for allowing water to pass therethrough from the well 110 to the ground beneath. It will be appreciated that in some embodiments, the plant aperture 111 will also allow water to pass therethrough.

In some embodiments, a plurality of water apertures 112 can be provided by use of a grid mesh base or flooring.

It will be appreciated that in some embodiments, the plant watering device 100 does not have a specific plant aperture 111, and only has one or more water apertures 112. In these embodiments, one or more plant watering devices 100 can be placed at the base of the plant to allow for focused watering of the area around the plant.

In other embodiments, the plant watering device 100 will have a plant aperture 111, and will be placed on the ground such that the plant aperture 111 is located above an area from which a plant will grow (e.g. where a seed has been planted), or over an already-newly-growing plant.

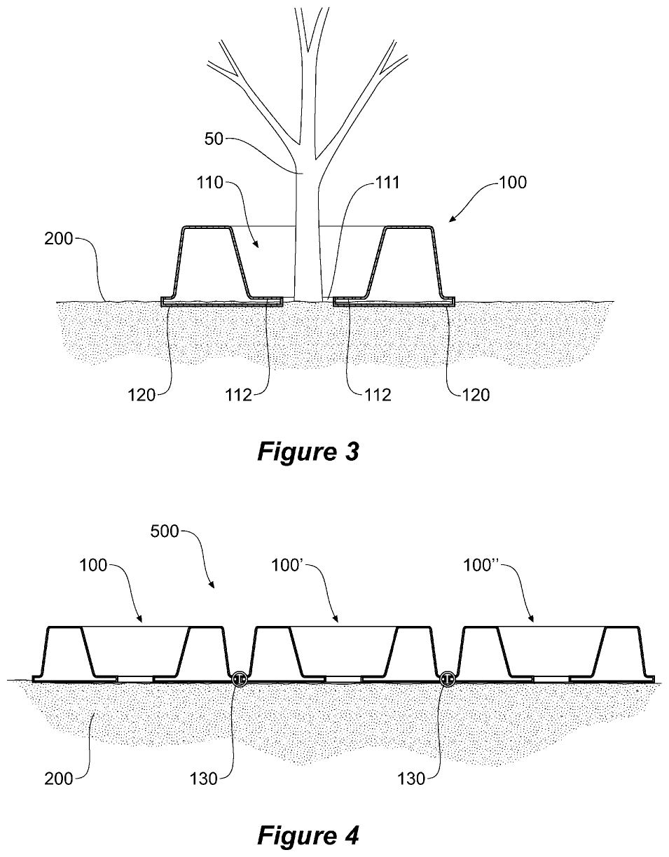

The well 110 may be of any suitable size and/or configuration. In some embodiments, the capacity of the well 110 is 5 litres. In other embodiments, the well capacity is between about 1 litre or less, to about 10 litres or more, including 2 litres, 3 litres, 4 litres, 6 litres, 7 litres, 8 litres, 9 litres, 11 litres, 12 litres, 13 litres, 14 litres, 15 litres, 16, litres, 17 litres, 18 litres, 19 litres, 20 litres, 21 litres or more. FIG. 3 shows a side cross-sectional view of plant watering device 100 disposed on the ground 200, with plant 50 growing through plant aperture 111, and well 110 provided about the plant 50. Water apertures 112 are also provided, to allow water in the well 110 to pass through to the ground 200 at the locations of the water apertures 112. As previously described, water will also flow through plant aperture 111, about the plant stalk. It will be appreciated that any suitable number of apertures could be provided, including 2 or more plant apertures and 2 or more water apertures, and including 2, 3, 4, 5, 6, 7, 8, 9 and 10 or more.

It will be appreciated that the plant watering device 100 provides many advantages. In particular, the water provided to the well 110 is provided to the soil beneath the device 100 in a directed and focused manner, reducing the amount of water that is spilled on the ground that does not directly benefit the plant. Using this system, water may be provided to a controlled depth, such as about 5 cm. This may also reduce the amount of weeds growing in the area, because water is less likely to be provided to the weeds, and the plant watering device 100 covering the ground above a weed may stifle its growth. This in turn reduces the need for the use of herbicides or other chemicals.

In some embodiments, parts or all of the body 105 may be provided as an opaque material or a material with a reduced transmissivity to light to prevent or reduce light from reaching weeds under the body.

Since the plant watering device also covers the ground where the water has been introduced, it can also reduce water loss due to evaporation.

In other aspects, a fertiliser for the plant 50 may be added to the water in the well, either in liquid form, or may be placed in the dry well 110 as a pellet or powder, to dissolve into the water to provide nutrients directly to the plant 50.

In some embodiments, base cover 120 is also provided, as will be described in more detail further below.

The placement of the plant watering device 100 on the ground around a plant can also reduce the instance of soil erosion by excess watering, wind or rain, as it provides a physical barrier to the elements for the soil.

FIG. 4 shows a plant watering system 500 comprising two or more plant watering devices 100, and in particular, three plant watering devices 100, 100′, 100″. FIG. 4 shows the plant watering devices 100, 100′, 100″ disposed on the ground 200 next to each other, and according to one aspect, at least detachably-connected to each other via respective connectors 130. Connectors 130 are shown in this view generally, but it will be appreciated that connector 130 can take on any suitable form, including a tab and slot arrangement, a sliding connector, a friction-fit connector, a magnetic connector, a snap-fit connector, a tongue-and-groove connector, an adhesive arrangement, a hook and loop arrangement, and/or a “jigsaw puzzle” type connector.

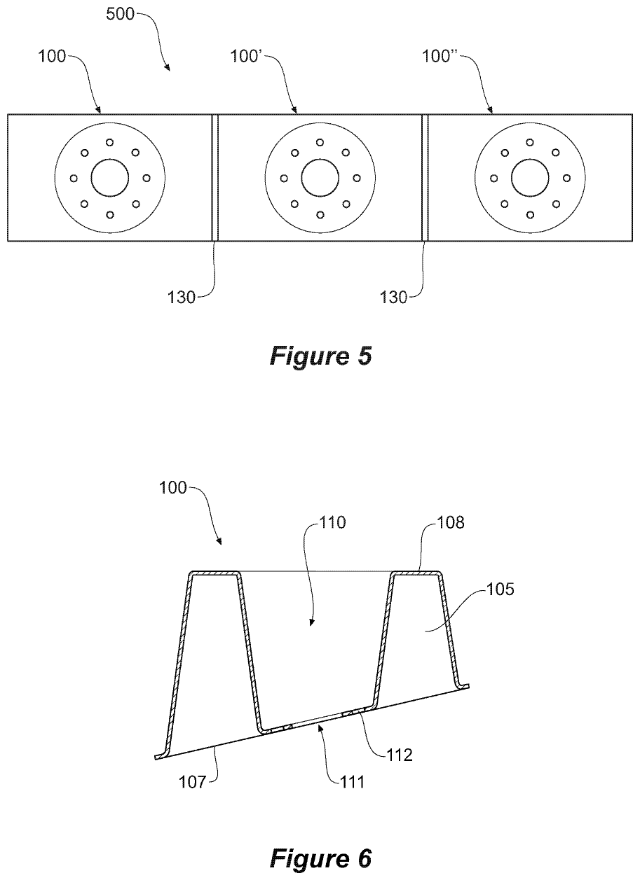

FIG. 5 shows a top view of the plant watering system of FIG. 4, showing the plant watering devices 100, 100′, 100″ connected together side-by-side.

It will also be appreciated, that the plant watering devices 100 can be connected to other plant watering devices on other sides as well, such that, in some embodiments, a plant watering device 100 is connected to, for example, 4 other plant watering devices 100′, 100″, 100′″, 100″″ to provide a matrix of such devices. In some embodiments, each of the other 4 plant watering devices are also themselves connected to multiple other plant watering devices 100 to allow the creation of a system being a “mat” of plant watering devices covering an area of land, with optionally, each device 100 having within its well, at least one plant growing therefrom.

It will also be appreciated, that in some embodiments, in which connectors 130 are not used or available, multiple plant watering devices 100 can simply be laid out next to each other in a desired configuration, with no connection therebetween.

It will also be appreciated that in some further embodiments, “spacers” may be used to increase the space between the plant watering devices 100. In some embodiments, these spacers are flat extensions of material that can be connected to each plant watering device 100 to thereby provide an extended system.

In some embodiments, plant watering device 100 comprises multiple bodies 105 with corresponding wells 110 and apertures 111. Such an arrangement can provide an alternative to connecting or otherwise side-by-side placing of, multiple plant watering devices. This aspect will be described in more detail further below.

According to another general aspect then, there is provided a plant watering system 500 comprising two or more plant watering devices 100. In some embodiments, the two or more plant watering devices 100 are connected together via at least one of their respective connectors 130.

It will be appreciated that the plant watering device 100 has a base 107, which comes into contact with the ground 200 when in use. According to another aspect, as shown in FIG. 6, the base 107 is angled with respect to the top 108 of the plant watering device 100. It will be appreciated that by “angled”, is meant “not substantially parallel” to the top 108.

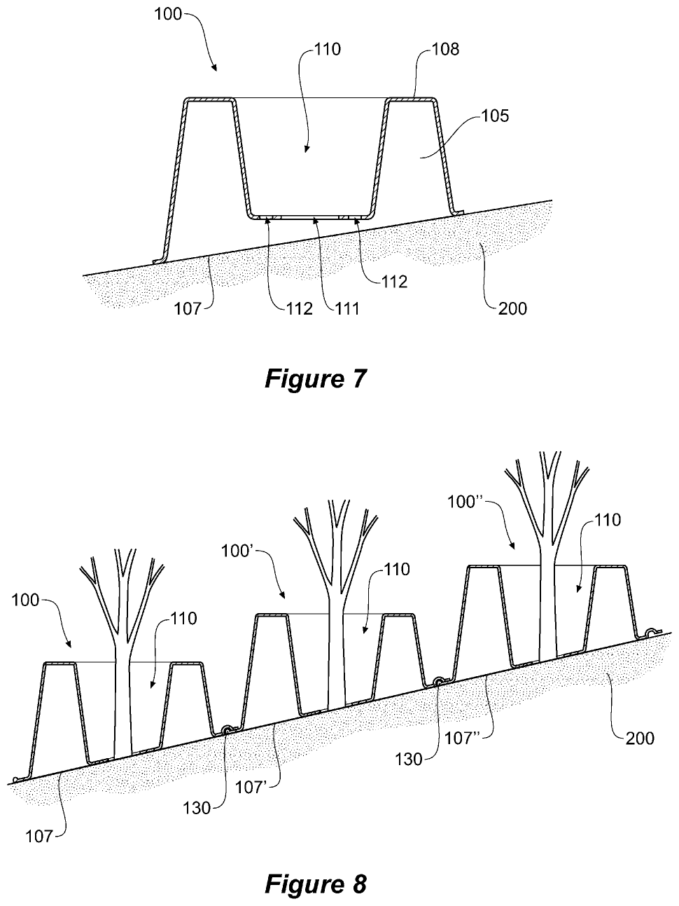

In some embodiments of this aspect as shown in FIG. 6, the base of the well 110 is in line with the base 107 (that is, also angled with respect to the top 108). In other embodiments, as shown in FIG. 7, the base of the well 110 is substantially parallel with the top 108, and thus the base 107 is angled with respect to the base of the well 110.

An advantage of having an angled base 107, is that a single plant watering device 110 can be placed on ground that is sloping. When creating a system 500 with two or more plant watering devices 100, such as shown in FIG. 8, the system 500 is able to be laid on the slope without sliding down. More importantly, as each plant watering device is able to deliver water from its respective well at a directed and localised area beneath the well, there is less likelihood of water wastage due to runoff, which can occur in current watering systems such as surface irrigation. This facilitates the use of otherwise unusable sloping land sites.

It will be appreciated that different plant watering devices 100 can be provided with a base 107 disposed at a range of different angles, to allow the user to select an appropriate set of plant watering devices according to the specific land slope, and indeed, cater for different slopes on the same tract of land by selecting a range of plant watering devices 100 with different base angles.

In some embodiments, the angle of the base 107 with respect to the top 108 and/or the bottom of the well 110, can range from less than 5°, to more than 60°, including 5° to 10°, 11° to 20°, 21° to 30°, 31° to 40°, 41° to 50° and 51° to 60° or more.

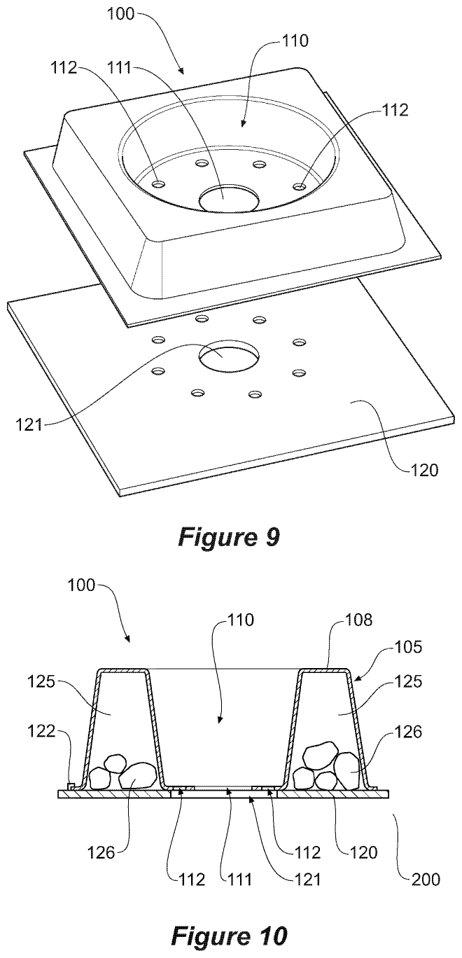

According to some other aspects, the plant watering device 100 is provided with a base cover 120 as shown in FIG. 9. In some embodiments, base cover 120 has a base cover aperture 121 which in use, is disposed under the well 110 of the plant watering device 100 to allow access to the plant aperture(s) 111 and the water aperture(s) 112 when the base cover 120 is connected to the plant watering device 100. As can be seen in FIG. 10, when base cover 120 is connected to the body 105 of plant watering device 100, a closed void 125 is created. This void 125 can be used to retain weighting material 126 such as rocks, sand, water, wood or any other material that will weigh down plant watering device 100 including soil conditioners, compost and, slow release fertilisers. This provides a more stable system, which can reduce the likelihood of the plant watering device 100 being displaced by wind, rain or animals, once in place on the ground.

In some embodiments, no base cover 120 is used, and there is no need to provide weighting material 126 to provide stability to the device 100. In some embodiments, the outer walls of body 105 are extended beyond the level of the bottom of the well 110 so that the walls can be inserted, pushed, or otherwise buried in the ground, thus providing a stable connection to the ground.

In some embodiments, the base cover 120 is able to be connected to the plant watering device 100 by way of a base cover connector 122. Base cover connector 122 can be any suitable connector, including, but not limited to, a tab and slot arrangement, a sliding connector, a friction-fit connector, a magnetic connector, a snap-fit connector, a hook and loop connector and a tongue-and-groove connector. In some embodiments, the base cover 120 can simply be attached to the plant watering device 100 by adhesive tape.

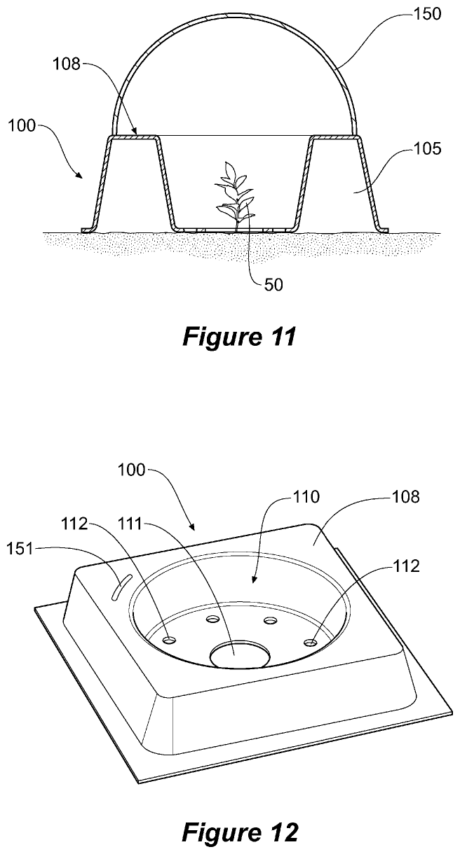

In some embodiments, plant watering device 100 can have a dome placed over the well 110 as shown in FIG. 11. The dome 150 can be any suitable shape, and may be made of any suitable material, including plastic or glass. The provision of the dome 150 can provide the plant watering device 100 with a “glass-house” effect to enhance the growing environment within the well 110, by retaining heat within, retaining moisture by reducing water evaporation, as well as providing protection to the growing plant 50 from animals and pests, when it is in the early stages of its growth. In use, the user simply removes the dome 150 from the body 105, pours the water into the well 110 and replaces the dome 150. In some embodiments, a movable cap or plug of the dome 150 is provided as will be described in more detail further below.

In some embodiments, the dome 150 simply sits upon the top 108 of the plant watering device 100. In some embodiments, dome 150 is connected to the plant watering device by a dome connector 151, as shown in FIG. 12. Dome connector 151 can be any suitable connector, including, but not limited to, a tab and slot arrangement, a sliding connector, a friction-fit connector, a magnetic connector, a snap-fit connector, a tongue-and-groove connector, an adhesive arrangement, and/or a hook and loop arrangement.

In some configurations, the dome 150 can be placed on its own around a seedling and optionally with the base to provide protection for the seedling's growth against harsh weather, pests, and animals, as well as deter close proximity weeds from overtaking the seedling.

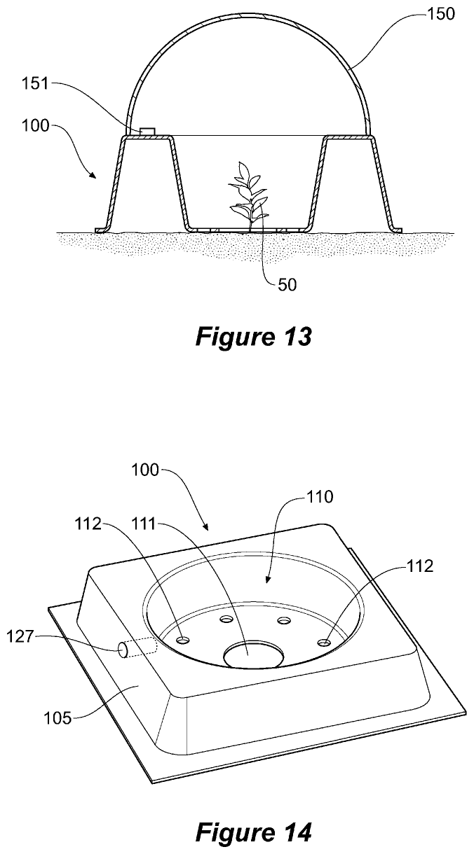

FIG. 13 shows the plant watering device 100 with dome 150 connected thereto via dome connector 151.

While the various aspects of the plant watering device 100 previously described provide an alternative to other watering methods, such as drip irrigation, in some aspects, the plant watering device 100 can be used in conjunction with such methods. For example, in some embodiments, plant watering device 100 also has an irrigation means 127, which allows the use of an irrigation system such as a drip irrigation system. FIG. 14 shows an example of a plant watering device 100 with an irrigation means 127 provided as an aperture in the body 105 to receive and support a nozzle from a drip irrigation system (not shown), to allow water to be delivered into the well 110 via the nozzle and/or to provide plumbing access to or interface with, an irrigation system.

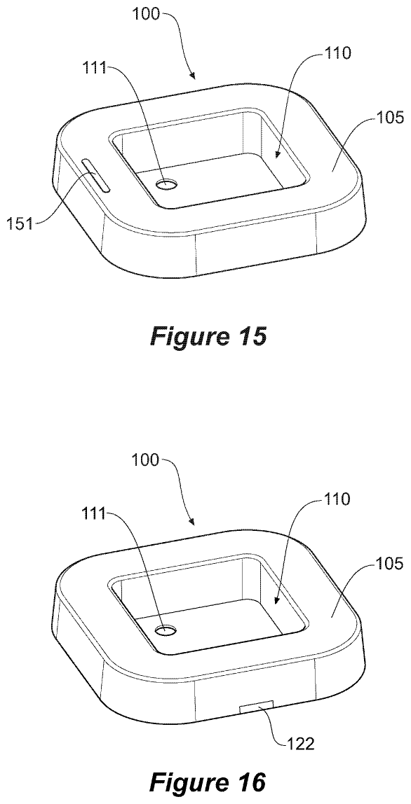

According to some other aspects, the plant watering device 100 does not require a connector 130. In some embodiments, the plant watering device 100 comprises a body 105 forming a well 110 for receiving water; at least one aperture 111 disposed in the well 110; and a dome connector 151 as shown in FIG. 15. As previously described, dome connector 151 can take the form of any suitable connector, including, but not limited to, a tab and slot arrangement, a sliding connector, a friction-fit connector, a magnetic connector, a snap-fit connector, a tongue-and-groove connector, an adhesive arrangement, and/or a hook and loop arrangement.

In some further aspects, plant watering device does not have a separate dome connector 151, but has dome 150 integrally formed therewith.

In these aspects, the plant watering device 100 can also have one or more of any of the other features previously described with respect to the first aspect having a connector 130.

According to some other aspects, the plant watering device 100 need not have the connector 130 or the dome connector 151. Thus, in some aspects, as shown in FIG. 16, the plant watering device 100 comprises a body 105 forming a well 110 for receiving water; at least one aperture 111 disposed in the well 110; and a base cover connector 122 for connecting to a base for forming a void between the base and the body for receiving material within the void.

In this aspect, the plant watering device 100 can also have one or more of any of the other features previously described with respect to the first aspect having a connector 130.

According to another aspect, there is provided a method of watering a plant, the method comprising providing water to the well 110 of at least one plant watering device 100 as previously described. This may be done by any means including by filling the well with a hose, or with a bucket.

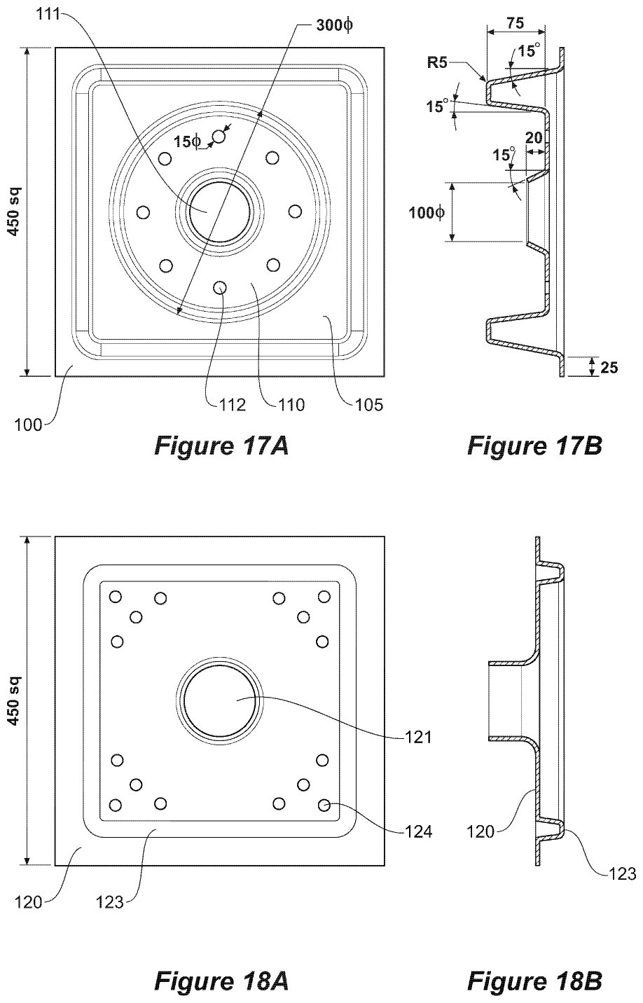

The various aspects described above will now be described in more detail with reference to FIGS. 17A to 23B.

FIGS. 17A and 17B show a plant watering device 100 according to a specific embodiment. FIG. 17A shows plan view of plant watering device 100 with body 105, well 110, plant aperture 111 and water apertures 112. FIG. 17B shows a cross-sectional side view of the plant watering device 100 along the line A-A of FIG. 17A. In this view, it can be seen that in this embodiment, the plant aperture 111 is raised from the base of the well 110.

In some aspects, this assists to direct water in the well 110 to the water apertures 112 to provide the water to the root system. It will be appreciated that the dimensions indicated in the FIGS. 17A, 17B are exemplary only, and may take on any other values in some embodiments as desired.

The plant watering device 100 can be made from any suitable material, including ceramics, metal, glass and plastics, including Polyethylene Terephthalate (PET) and High Density Polyethylene (HDPE), composite materials, and natural materials such as pressed bamboo or other plant material, and may be formed by any suitable process including injection moulding, extrusion, casting and vacuum formed. In some embodiments, the thickness of the material is 2 mm, but can be any suitable thickness including about 1 mm, about 2 mm, about 3 mm, about 4 mm, about 5 mm, less than about 1 mm and more than about 5 mm.

In some embodiments, plant watering device 100 is clear or translucent to sunlight. In some embodiments, plant watering device 100 is coloured, for example silvered, so as to partially reflect sunlight to reduce excess heat building up around the plant in the early stages of growth. In some embodiments, the reflection of sunlight can be used to reflect the sunlight back onto the leaves of the plant to expose more of the plant to sunlight to enhance photosynthesis to promote better growth.

FIGS. 18A and 18B show the base cover 120 according to a particular embodiment. FIG. 18A shows a plan view of the base cover 120, including drain apertures 124 which allow water draining from the water apertures 112 of the well 110 to drain through to the ground beneath the base cover 120 when attached to the body 105. Base cover aperture 121, in this embodiment, in use, engages with water aperture 112 of well 110 to allow the plant (not shown) to be received by the plant aperture 111. It will be appreciated that the raised base cover aperture 121 allows for a “mating” connection with the plant aperture 111 to provide a more robust and secure connection of the base cover 120 to the body 105, however, in some embodiments, the base cover aperture 121 need not be raised and may simply be disposed in alignment with and below the plant aperture 111.

In some embodiments, a portion of the base cover 120 is extended, to provide one or more base cover protrusions 123. In use, base cover protrusions dig into the soil under the base cover 120 to provide positive engagement or locking into the ground, thereby providing more stability to the plant watering device 100 when in situ.

The base cover 120 can be made of any suitable material, including ceramics, metal, glass and plastics, including Polyethylene Terephthalate (PET) and High Density Polyethylene (HDPE) and may be formed by any suitable process including injection moulding and vacuum formed. In some embodiments, the thickness of the material is 2 mm, but can be any suitable thickness including about 1 mm, about 2 mm, about 3 mm, about 4 mm, about 5 mm, less than about 1 mm and more than about 5 mm.

In some embodiments, base cover 120 is clear or translucent to sunlight. In some embodiments, base cover 120 is coloured, for example black, so as to prevent sunlight reaching the soil underneath the plant watering device 100 to thereby impede the growth of weeds or other unwanted plant types, around the growing target plant. The provision of a black or otherwise opaque base, also impedes growth of algae to the underside of the base 120.

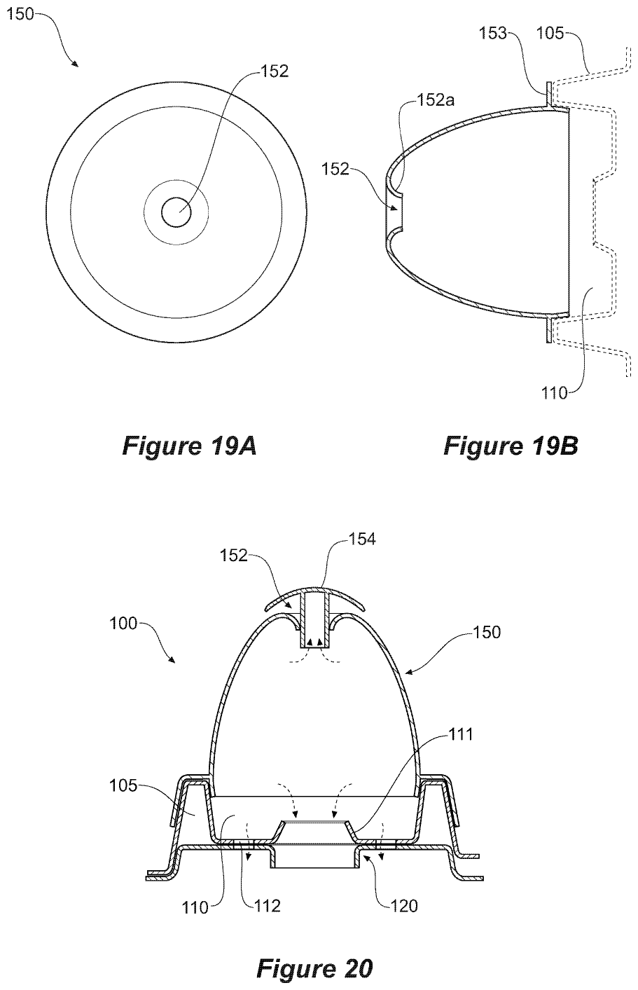

FIGS. 19A and 19B show dome 150 according to a specific embodiment. FIG. 19A shows a top view of dome 150 with dome aperture 152 and dome flange 155. FIG. 19B shows a side view of dome 150. As can be seen in this view, in this embodiment, dome aperture 152 has a curved inlet 152a to allow for condensate return to cause evaporated moisture that condenses on the inside of the dome near the aperture 152 to drip back into the well 110.

As can be seen in the view of FIG. 19B, in use in this embodiment, dome 150 sits on the top of base 105, via the flange 153 which extends about at least a part of the periphery of the dome.

FIG. 20 shows a plant watering device 100 comprising the body 105 with well 110, engaged with base cover 120, and dome 150 in place over the well 110. In some embodiments, as shown in FIG. 20, dome 150 also has dome aperture plug 154 situated within dome aperture 152. In some embodiments, dome aperture plug 154 is able to be moved from a closed position, which in the view of FIG. 20 would be in a lowered position so that the top of dome aperture plug 154 closes the dome aperture 152 entirely, to an open position, which is as shown in FIG. 20, provides one or more open spaces around dome aperture 152 to promote airflow.

According to another aspect therefore, there is provided a dome for use with a plant watering device as claimed in any one of claims 1 to 12, the dome comprising a dome aperture at a top of the dome; and a dome aperture plug disposed at the dome aperture and moveable between a closed position and an open position, the open position providing for airflow through the dome aperture.

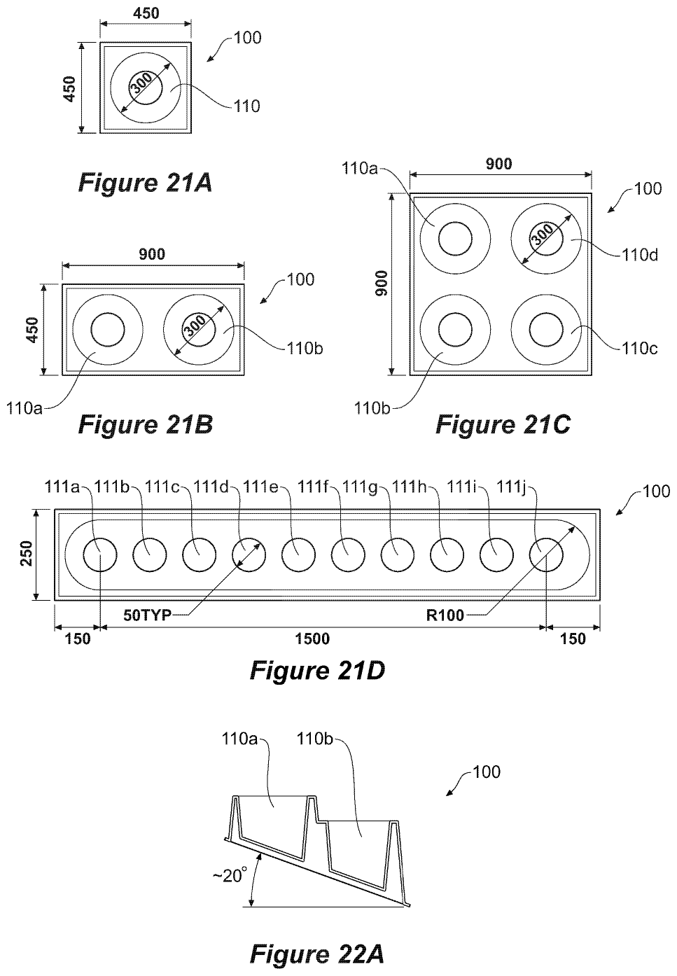

FIGS. 21A to 21D show a top view of a number of embodiments of plant watering device 100. In FIG. 21A, plant watering device 100 has a single well 110. Such an arrangement may be used for a range of plants including tomatoes, capsicum, eggplants, rockmelons, watermelons, zucchini, pumpkins, spinach, broccoli and cauliflower.

FIG. 21B shows plant watering device 100 with two wells 110a, 110b. As will be appreciated, in these embodiments, plant watering device is a single, integrated piece, simply with multiple wells. Such an arrangement may be used for a range of plants including tomatoes, capsicum, eggplants, spinach, broccoli and cauliflower.

FIG. 21C shows a plant watering device 100 with four wells 110a, 110b, 110c and 110d, arranged in a square. Such an arrangement may be used for a range of plants including tomatoes, capsicum, eggplants, spinach, broccoli and cauliflower.

FIG. 21D shows a plant watering device 100 with one well 110 but with ten plant apertures 111a, 111b, 111c, 111d, 111e, 111f, 111g, 111h and 111i, arranged in a long row. This allows a row of closely-spaced plants to be cultivated from a single plant watering device 100. While in this embodiment, water from the filled well 110 will pass through the respective plant apertures, in some embodiments, further water apertures 112 (not shown) can be provided as well. Such an arrangement may be used for a range of plants including spinach, broccoli, cauliflower, beans, parsley and bok choy.

In some embodiments of the multi-well plant watering devices 100 as shown in FIGS. 21A to 21D, “snap out” or “push-out” sections can be provided at the base of one or more of the wells 110 to allow the creation of one or more plant apertures at the selection of the user. This accommodates for use of the multi-well device with fewer plants than the number of wells 110, or to accommodate planting strategies with more spacing between plants. This also reduces weed growth where no plants are placed in a particular well that would otherwise have a plant aperture therein.

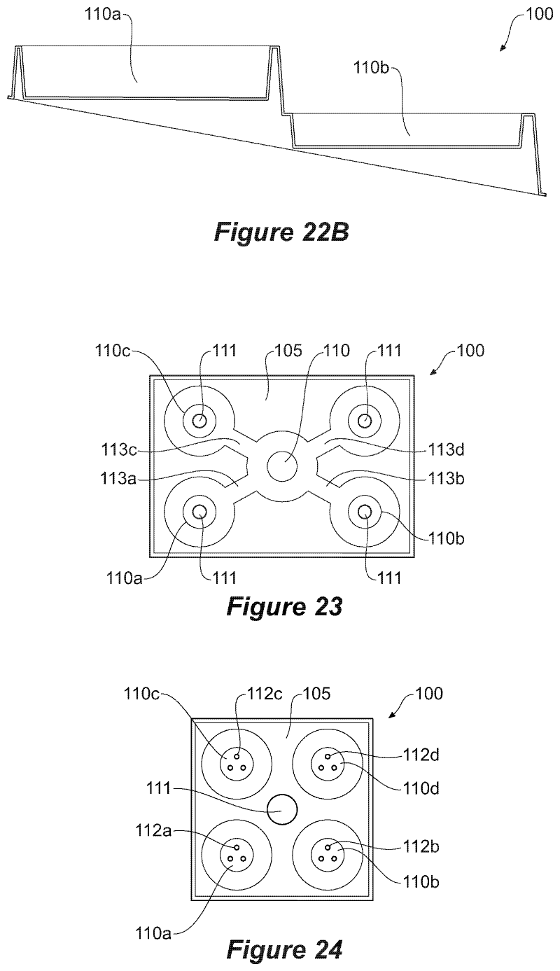

FIGS. 22A and 22B show a side view of embodiments of the plant watering devices 100 of FIGS. 21C and 21D respectively, using the stepped design to allow for use on a slope as previously discussed. In an embodiment as shown in FIG. 22A, the base of the wells 110a, 110b are shown as angled, in line with the base, but in some embodiments, the base of one or more of the wells can be substantially horizontal, as is shown in the embodiment of FIG. 22B. In other embodiments of the arrangement shown in FIG. 22B, the base of one or more of the wells, 110a, 110b could be angled in line with the base 107 as shown in the embodiment of FIG. 22A.

In yet a further embodiment as shown in FIG. 23, plant watering device 100 is provided with a body 105 within which are formed a plurality of wells (five wells 110, 110a, 110b, 110c, 110d in this case). In this embodiment, there is provided a central well 110 with no aperture at all. Four other wells 110a, 110b, 110c and 110d surround central well 110, and are connected via a respective channel 113a, 113b, 113c, 113d, which can convey water from central well 110 to respective wells 110a, 110b, 110c, 110d. These surrounding wells comprise respective plant apertures 111a, 111b, 111c, 111d for receiving a respective plant and providing water thereto. Each of these surrounding wells may also have in some embodiments, respective water apertures 112. This arrangement allows for a more convenient method of filling multiple wells, by simply filling a single well.

In yet further embodiments, as shown in FIG. 24, there is provided a plant watering device 100 with a body 105, a central plant aperture 111 and a plurality (for example four in this particular embodiment shown) wells 110a, 110b, 110c, 110d surrounding the plant aperture 111. In this arrangement, the plant watering device 100 can be placed over a plant (not shown) which in use, grows through plant aperture 111, and then the surrounding wells can be filled with water which then drains into the ground surrounding the plant via respective water apertures 112a, 112b, 1112c, 112d to provide water and any applied nutrients to the surrounding root system about the plant.

In further embodiments of the examples shown and described with reference to FIG. 21D for example, a plant watering device 100 is provided as a “valley” with a plurality of plant apertures 111. In some embodiments, such a device may be constructed through extrusion, and may be provided to any suitable length, for example, 1 m, 2 m, 3 m or more, and or any length therebetween.

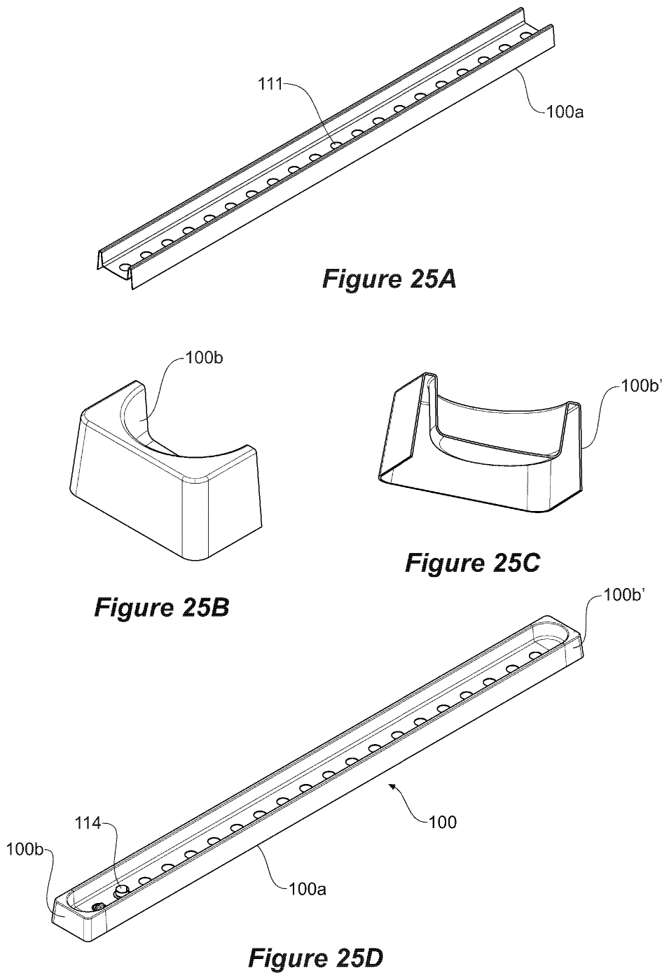

FIG. 25A shows an embodiment of an extruded length 100a comprising a plurality of plant apertures 111. End caps 100b, 100b′ are shown in FIGS. 25B and 25C respectively. These end caps may be formed by any suitable means including injection moulding, vacuum forming or pressing. End caps 100b, 100b′ can then be attached to the extruded section 100a by any suitable means, including hot plate welding, using plastic glues or any other bonding processes, to form watering device 100 as shown in FIG. 25D.

In one aspect then, there is provided a plant watering device comprising: a body forming a well for receiving water; and a plurality of apertures disposed in the well; wherein the body comprises an extruded section with an end cap at each end.

In other embodiments of this aspect, there is provided a means of controlling the flow of water through the valley by inserting a spigot 114 into one or more of the plant apertures 111, which may also be acting as water apertures 112. FIG. 25D shows an embodiment in which a spigot 114 is inserted into one of the apertures 111. It will be appreciated that apertures 111 or 112 can be of any suitable diameter, including 5 mm, 1 mm to less than 5 mm, between 5 mm and 10 mm, 10 mm, between 10 mm and 20 mm and greater.

In some embodiments, apertures with different diameters may be provided depending on the use. For example, a row of larger apertures (e.g. 20 mm) can be provided as shown here, but with additional smaller apertures (e.g. 5 mm) which may provide additional drainage.

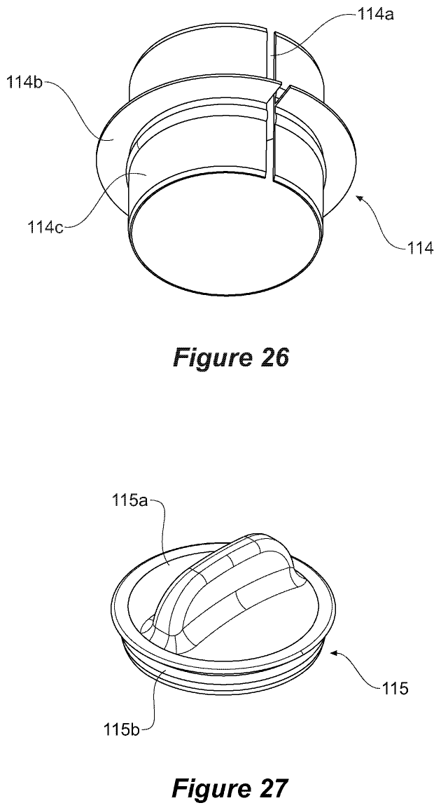

FIG. 26 shows an embodiment of a spigot 114. As can be seen, spigot 114 comprises a body 114c, in which is disposed a slit 114a. Slit 114a in use, provides a restricted aperture for water flow, allowing control of the flow of water from one end to another.

As can be seen in FIG. 26, a rim 114b is also provided about body 114c which in use, sits on the floor of the valley and keeps spigot 114 in place within aperture 111.

In some embodiments, the neck of spigot 114 can be extended to provide a larger “container” for soil to accommodate plants such as tomato plants which can generate root tendrils along the length of its main root.

In other aspects, apertures 111 can be completely closed off by use of a plug 115. An example of a plug 115 is shown in FIG. 27. In the embodiment shown in FIG. 27, plug 115 comprises a handle 115a and a screw thread 115b to allow the plug to be screwed into a respective aperture 111. In these embodiments, the apertures 111 will have a corresponding thread to engage with thread 115b. In other embodiments, the thread 115b is replaced with a surface that provides a friction fit with the aperture 111 upon pushing in the plug 115. In some embodiments, this surface is a rubber surface. In other embodiments, there is no positive “fixing” engagement with the aperture 111 and the plug 115 simply sits within and on top of the aperture to prevent water from entering that aperture.

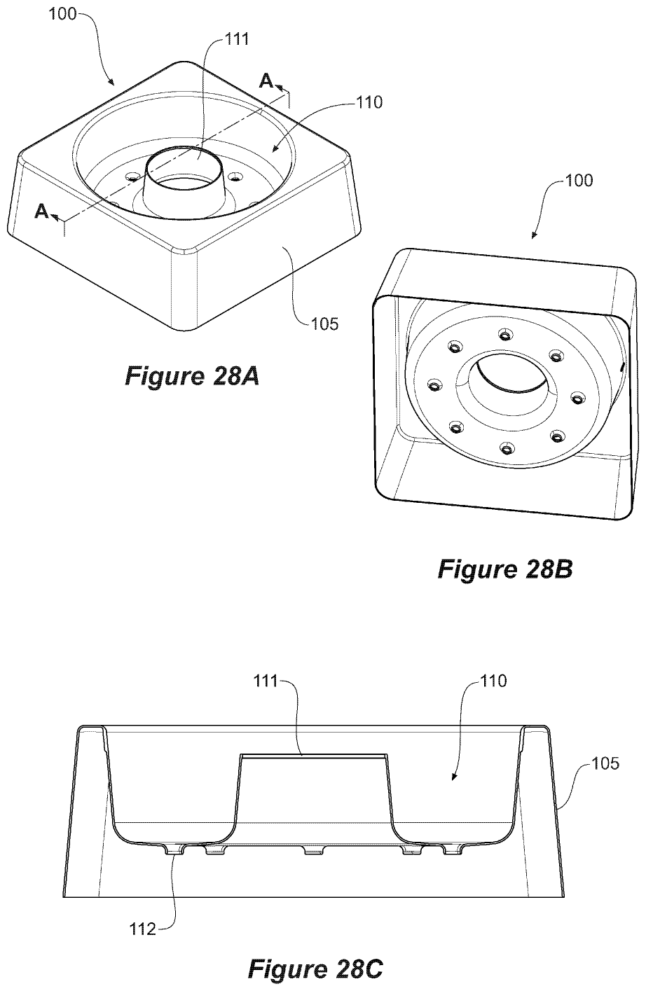

FIGS. 28A, 28B and 28C show another embodiment of plant watering device 100. This embodiment is as previously referred to, in which the walls of the body 105 extend beyond the level of the base of the well 110. This allows the device 100 to be partially buried into the ground so that the base of the well 110 lies on the ground, and the end walls extend into the ground, to provide stability against wind and small animals for example.

In some embodiments, a lid or plug may also be placed directly over the plant aperture 12, which forms a “green-house” effect. This is an alternative to the use of a dome as previously described.

In some embodiments, the neck of the device 100 forming the plant aperture 111 can itself be filled with soils and/or compost to enable: increased opportunity for root growth from the stem (e.g. tomato plants); limit the ingress of rodents such as mice; and provide increased moisture retention within the neck.

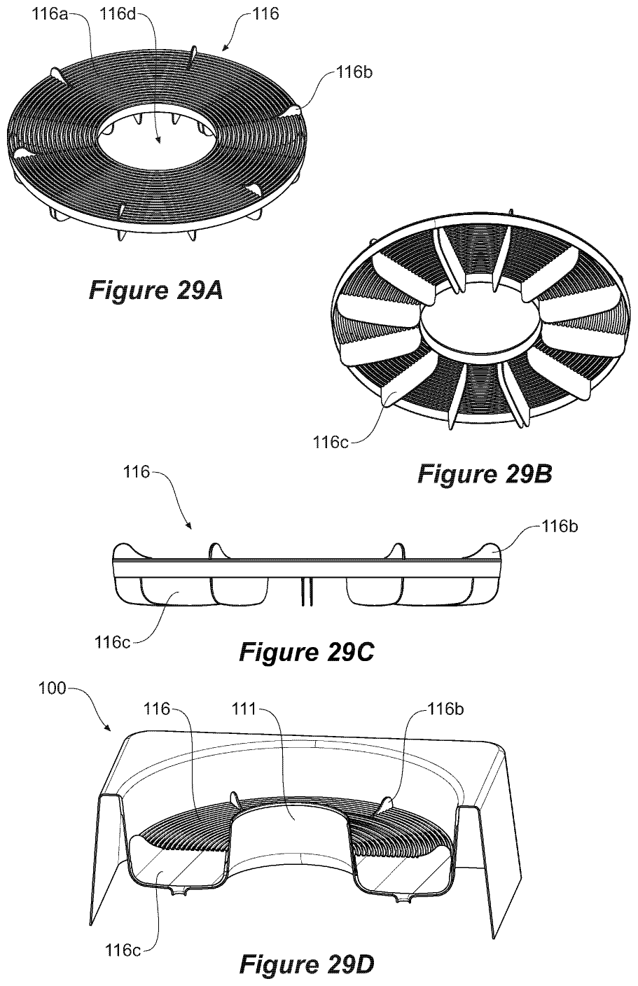

FIGS. 29A, 29B, 29C and 29D show an optional additional feature, in the form of a disk 116. FIG. 29A shows a top-perspective view of disk 116, comprising a body 116a and one or more tabs 116b on the top surface, and one or more blades 116c on the bottom surface (see FIG. 29B). Within the body 116a, is an aperture 116d which in use, is placed over the plant aperture 111. In some embodiments, disk slits or other apertures may be provided within the body 116a through which water may pass.

In use, the disk 116 is placed on the bottom of the well 110, with the blades 116c resting on the surface of the bottom of the well 110. This provides a platform which can set above the bottom of the well 110 and provides a cover over water apertures 112 to prevent or reduce the instance of debris falling into or covering the water apertures 112.

In some embodiments, the disk 116 provides a water-dispersing function by receiving and covering water inserted into the well, thereby reducing splash-back and increasing the water-conservation of the system.

In some other applications, the ability of the disk 116 to provide a raised platform provides additional growing benefits to certain plant types such as strawberries. These types of plants that grow in a spread-out fashion from the main stalk and normally on the ground, benefit from being raised above the floor of the well 110 so as not to lie in moisture for an extended period of time.

In some other applications, the disk 116 can act as a barrier to crawling insects or creatures such as slugs or snails that may enter the well from underneath.

In another use, the disk 116 can be turned about the axis of aperture 116d, causing blades 116c to scrape along the bottom of well 110 to “cut” or “scrape” away any weeds or other undesirable growth that may be growing through the plant apertures 111.

To effect this action, the user simply engages one or more of the tabs 116b of the disk 116 and twists the disk 116 around the axis. The user can also push down on the disk as it is twisted to provide a stronger cutting or scraping action.

In some embodiments, only one blade 116c is provided. In this case, the disk 116 must be twisted around a full 360° to cover the entire floor of the well 110. In other embodiments, two blades 116c are provided opposite each other, requiring a 180° turn. In other embodiments, 4 blades 116c are provided, 90° apart, requiring a quarter-turn of the disk 116. In other embodiments, as shown in FIG. 29B, 12 blades 116c are provided, set 30° apart, requiring only a slight twist of 30° to cover the entire surface of the base of well 110.

In some embodiments, still, disk 116 can be formed in two halves, allowing the disk 116 to be placed in the well 110 around an existing plant.

FIG. 29D shows an example of the disk 116 placed within the plant watering device 100.

In one aspect then, there is provided a plant watering device comprising: a body forming a well for receiving water; at least one plant aperture disposed in the well for receiving a plant; at least one water aperture disposed in a base of the well for allowing water to pass therethrough; and a disk rotatably disposed in the well, the disk comprising a body, at least one blade on one side of the body such that in use, upon rotation by a user of the disk within the well, the blade scrapes along the base of the well.

In some aspects, there is also provided a disk comprising a body having a central aperture; and at least one blade extending from one side of the body. In some embodiments, there are 2, 3, 4, 5, 6, 7, 8, 9, 10, 11, 12 or more blades. In some embodiments, the other side of the body comprises at least one tab for engagement by a user to effect the rotation.

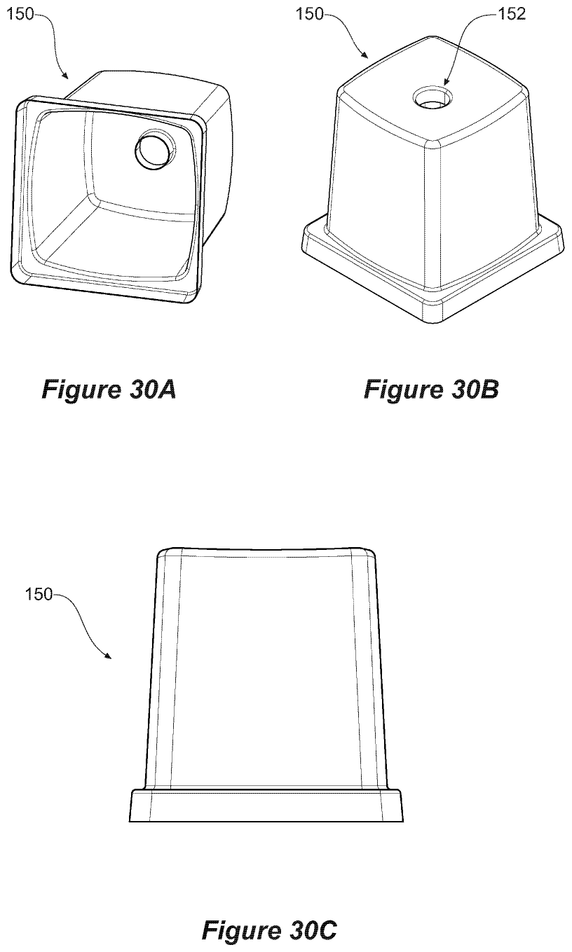

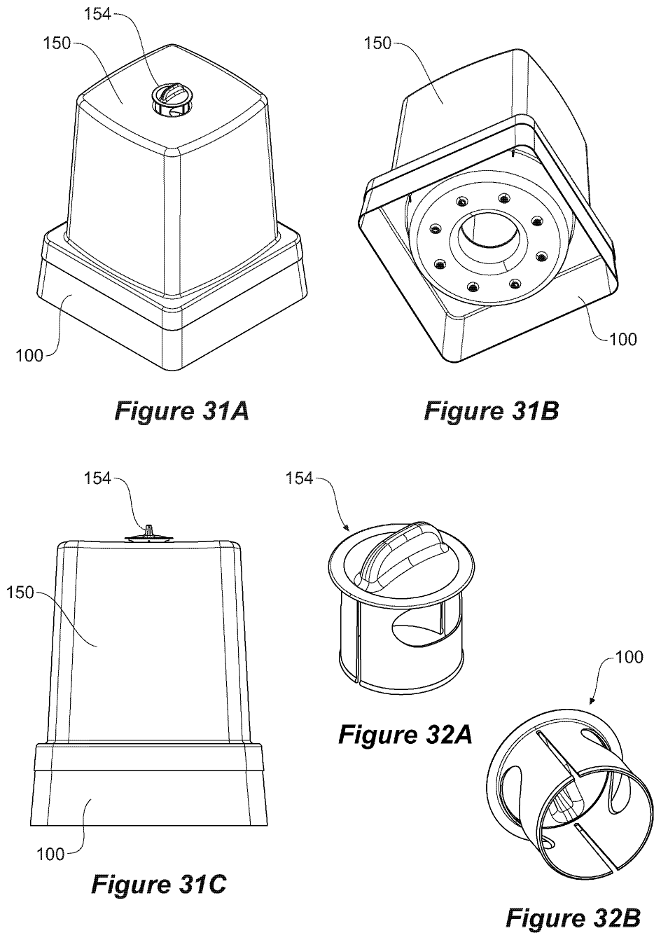

FIGS. 30A, 30B and 30C show another embodiment of dome 150, with dome aperture 152. This dome 150 is formed so as to fit the plant watering device 100 of the embodiment described and shown with reference to FIGS. 28A and 28B. FIGS. 31A, 31B and 31C show a top perspective view, and bottom perspective view, and a side view respectively of the dome 150 placed on top of the device 100.

FIGS. 31A and 31C also show a dome aperture plug 154 inserted into dome aperture 152. In the view of FIG. 31A, the plug is in the open position, and in that of FIG. 31C, the plug 154 is in the closed position, as previously described.

It will also be appreciated that the open position of the plug 154 also allows for general airflow as well as ingress of water, for example, through rainfall and/or manual watering.

FIGS. 32A and 32B show perspective views of an embodiment of dome aperture plug 154.

In yet another aspect, the plant watering device 100 is provided as a paver (or tile) insert. That is, the device 100 is shaped so as to be able to be laid amongst pavers. In some embodiments, a paved area can be laid over ground using standard pavers, and in some areas, pavers can be laid against each of the four sides of device 100. In other embodiments, a pre-paved area can be used, in which one or more of the pre-laid pavers is removed and replaced with the device 100.

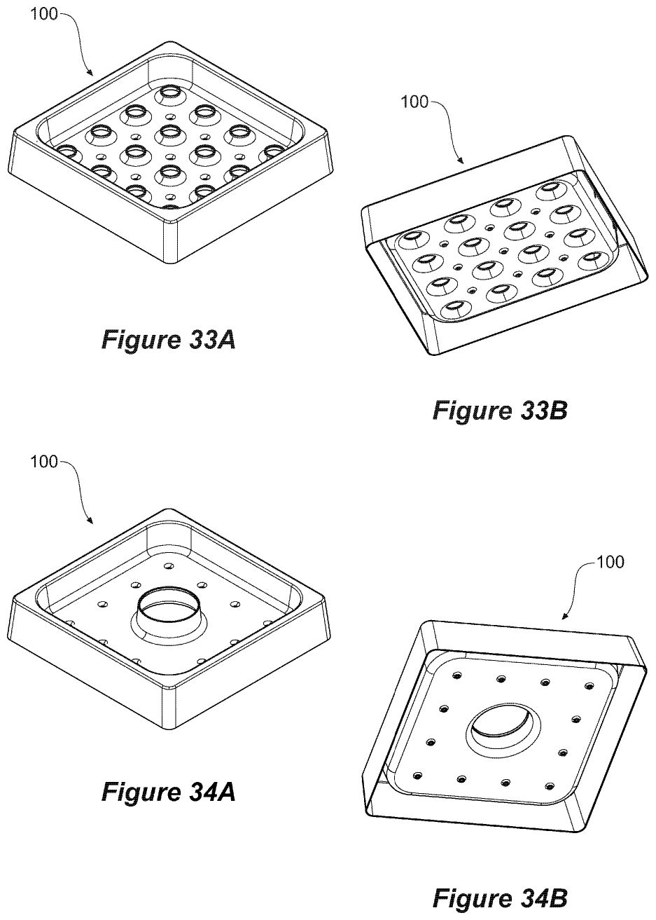

FIGS. 33A, 33B, 34A, 34B, 35A, 35B, 36A and 36B show a range of different plant watering devices 100 according to this aspect.

FIG. 33A shows a top perspective view of device 100 with multiple plant apertures 111 and water apertures 112, within well 110. FIG. 33B shows a bottom perspective view of this embodiment.

FIG. 34A shows a top perspective view of device 100 with a single plant aperture 111 and a plurality of water apertures 112. FIG. 34B shows a bottom perspective view of this embodiment.

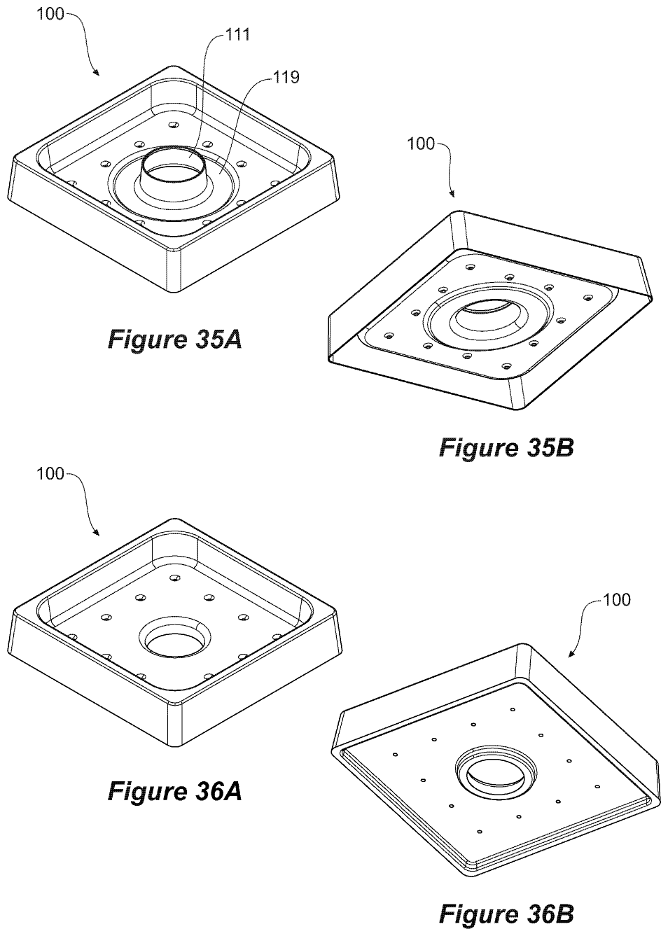

FIG. 35A shows a top perspective view of device 100 with a single plant aperture 111 and a plurality of water apertures 112. In this embodiment, a depression 117 is formed in a ring around the plant aperture 111. In use, this depression fills with water to form a moat 119 around the plant aperture 111. This moat 119 can provide protection to the newly-growing plant from crawling insects. FIG. 35B shows a bottom perspective view of this embodiment.

FIGS. 36A and 36B shows another embodiment of device 100 in which the device 100 may itself be used as a paver, In these embodiments, device 100 may be made from any suitable materials such as concrete, ceramic, stone, clay or even wood. In this aspect, a “floor” of such pavers or tiles can be laid to provide an expanse of plant watering devices 100. Of course, devices of this aspect may also be used in conjunction with one or more traditional pavers as with the embodiments of FIGS. 33A to 35B.

It will be appreciated that in many of these aspects and embodiments, the plant watering device 100 is stackable with other plant watering devices 100, allowing easy and efficient storage and transport. In some aspects, the plant watering device 100 is also reusable from one application to another, reducing the cost of running the system and providing environmental benefits in not having to dispose of each device after each use.

According to another aspect, there is provided a method of watering a plurality of plants, the method comprising providing water to the respective wells of the two or more plant watering devices of the system as previously described. This may be done by any means including by filling the well with a hose, or with a bucket. In some embodiments still, a system of plant watering devices as previously described can also provide benefits in an arrangement where the wells 110 are filled by a sprinkler or micro irrigation system. The plant watering system 500 increases the efficiency of a standard sprinkler system by allowing the water generally sprayed by the sprinklers to be accumulated into the respective wells and deposited directly in a focused manner to the area around the respective plants 50.

The various aspects, arrangements and embodiments described above provide many advantages, some of which are listed below.

Better water management:
controlled volume watering (e.g. 3 inch or about 7.5 cm depth)
much reduced water consumption of non-vegetated areas
much reduced water loss by evaporation
advantages over drip irrigation by avoiding water channeling
eliminates or reduces the need for consideration of varying soil conditions and water retention rates

Lower Setup and Running Costs:
Reduced design/installation costs compared to micro irrigation systems
Eliminates or reduces costly soil levelling for water channeling
Eliminates or reduces costly analysis of soil permeability for water flow
Easy start-up to final pack-up
Allows for localised spot tilling (e.g. in cases in which the root zone relative to the plant size is much smaller, for example in planting of water melons)
Product longevity and reusability
Eliminates or reduces surrounding weed growth and thus labour-intensive weeding and reducing the use of herbicides
Eliminates or reduces the need for costly straw bedding for weed control and evaporation loss
Provides controlled and direct feeding of nutrients
Enables packet-style focused nutrient feeding
Reduces amount and expenses of nutrients

Improved Plant Growth:
Suitable for a wide variety of plants
Cleaner produce (e.g. strawberry planting)
Eliminates or reduces plant contamination via soil splash
Enables earlier planting seedling propagation using glass house cover concept
Earlier planting and in-situ growing of seedling reduces environmental shock

Increased Land Suitability:
Suitable for rockier soils reducing soil preparation
Allows full ground coverage reducing soil erosion
Suitable for sloping lands, whilst avoiding water run-off
Eliminates or reduces rodent and animal water channel damage
Suitable for sandier soils, avoiding water channeling
Reduced plant and row spacing is possible, thereby providing better land utilisation (or less land required for cultivating)

Environmental Impact Benefits:
Reclaim use of plastic regrind from PET bottles in product
Reduced soil erosion
Reduced downstream contamination via excess nutrients and pesticide run-off
Eliminates or reduces plastic mulch and drip irrigation waste material at the end of the cultivation cycle

Product Suitability:
Various design options for different plant methods
Suitable for domestic and commercial applications requiring less or no tilling
Suitable for commercial application
Reduced watering times
Suited to manual watering methods
Manual watering method offset by labour in selective weed control/soil preparation
Can be integrated with irrigation pipes for “high flow” watering

Major Local Government Incentives:
Increased water conservation
Increased use of remote land possible
Increased workforce
Utilisation of regrind plastics from PET bottles for components production
Reduced downstream contamination from over application of fertilisers
Eliminates or reduces plastic mulch and drip irrigation waste material at the end of the cultivation cycle

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

What is claimed is:

1-26. (canceled)

27. A plant watering device for watering a plant, comprising:
a body forming a well for receiving water;
at least one plant aperture disposed in a base of the well for receiving at least a part of the plant; and
at least one water aperture disposed in the base of the well for allowing water in the well to pass therethrough.

28. A plant watering device as claimed in claim 27 further comprising a base for contacting the ground when in use.

29. A plant watering device as claimed in claim 28 wherein the base is angled with respect to a top of the plant watering device.

30. A plant watering device as claimed in claim 28 comprising a dome covering the well

31. A plant watering device as claimed in claim 28 comprising a dome connector for connecting a detachable dome for covering the well.

32. A plant watering device as claimed in claim 31 comprising the dome connected thereto.

33. A plant watering device as claimed in claim 28 further comprising means for receiving a part of an external irrigation system for providing the water to the well.

34. A plant watering device as claimed in claim 28 further comprising at least one connector for engaging with a corresponding connector of another plant watering device.

35. A plant watering device as claimed in claim 32, the dome comprising:
a dome aperture at a top of the dome; and
a dome aperture plug disposed at the dome aperture and moveable between a closed position and an open position, the open position providing for airflow through the dome aperture.

36. A plant watering system comprising two or more plant watering devices as claimed in claim 34.

37. A plant watering system as claimed in claim 36 wherein the two or more plant watering devices are connected together via at least one of their respective connectors.

38. A plant watering system as claimed in claim 37 wherein the two or more watering devices each receive, in use, a plant through their respective at least one aperture.

39. A plant watering device comprising:
a body forming a well for receiving water; and
a plurality of apertures disposed in the well; wherein the body comprises an extruded section with an end cap at each end.

40. A plant watering device as claimed in claim 39 comprising at least one spigot disposed in at least one respective aperture for limiting the flow of water through the at least one respective aperture.

41. A plant watering device as claimed in claim 39 further comprising at least one plug

42. A plant watering device as claimed in claim 27 further comprising:
a disk rotatably disposed in the well, the disk comprising a body, at least one blade on one side of the body such that in use, upon rotation by a user of the disk within the well, the blade scrapes along the base of the well.

43. A plant watering device as claimed in claim 42 wherein the disk further comprises at least one tab on another side of the body for engagement by the user to effect said rotation.

44. A plant watering device as claimed in claim 42 wherein the disk is provided in two halves.

45. A plant watering device as claimed in claim 28 wherein the plant watering device is a paver.

46. A plant watering device as claimed in claim 39 wherein the plant watering device is a paver.
